(19) United States
(12) Patent Application Publication
(10) Pub. No.: US 2017/0306528 A1
(43) Pub. Date: Oct. 26, 2017

(54) METHOD FOR MANUFACTURING SUPER ABSORBENT POLYMER FIBER

(71) Applicant: LG Chem, Ltd., Seoul (KR)

(72) Inventors: Jin-Seok Seo, Daejeon (KR); Young Sam Kim, Daejeon (KR)

(73) Assignee: LG Chem, Ltd., Seoul (KR)

(21) Appl. No.: 15/518,291

(22) PCT Filed: Sep. 2, 2016
(86) PCT No.: PCT/KR2016/009856

§ 371 Date: Apr. 11, 2017

(30) Foreign Application Priority Data
Sep. 4, 2015 (KR) 10-2015-0125535
Aug. 22, 2016 (KR) 10-2016-0106096

(51) Int. Cl. D01D 5/18; D01G 99/00; C08L 23/08; C08L 33/26

(52) U.S. Cl. CPC D01D 5/18; C08L 33/26; D01G 99/005; C08L 23/0853; C08L 2312/00; C08L 2203/12

(57) ABSTRACT

This invention relates to a method of manufacturing a superabsorbent polymer fiber and a superabsorbent polymer fiber manufactured thereby.

### TECHNICAL FIELD

This application claims the benefit of Korean Patent Application Nos. 10-2015-0125535, filed Sep. 4, 2015, and 10-2016-0106096, filed Aug. 22, 2016, which are hereby incorporated by reference in their entireties into this application.

The present invention relates to a method of manufacturing a superabsorbent polymer fiber.

### BACKGROUND ART

Superabsorbent polymers (SAPs) are synthetic polymer materials that are able to absorb about 500 to 1000 times their own weight in moisture. Such superabsorbent polymers have begun to be used in real-world applications for sanitary items, and are currently being widely employed not only in hygiene products, such as disposable baby diapers and the like, but also in soil conditioners for gardening applications, water-stopping agents for civil engineering and construction applications, sheets for raising seedlings, freshness preservatives for food distribution, fomentation materials, etc. Accordingly, superabsorbent polymers (SAPs), which are known to have outstanding absorption capability compared to existing absorbents, are utilized in a wide variety of applications, and thus the market competitiveness thereof is regarded as high.

Currently useful superabsorbent polymers are prepared in the form of a powder. Such a superabsorbent polymer powder may be scattered or may leak when manufacturing hygiene materials or upon real-world application, and the use range thereof is limited because it has to be used together with a specific type of substrate. Furthermore, the process of manufacturing a superabsorbent polymer powder is complicated and involves many factors that must be controlled.

### DISCLOSURE

### Technical Problem

Therefore, the present invention has been made keeping in mind the problems encountered in the related art, and the present invention is intended to provide a novel type of fiber having a superabsorbent polymer function, which entails no concern of scattering or leaking because it is provided in the form of a nonwoven fabric, unlike a superabsorbent polymer powder, and moreover which may be directly spun on a substrate during the production thereof, thus simplifying the manufacturing process. In addition, the present invention is intended to provide a method of manufacturing a superabsorbent polymer fiber, the application range of which is broad thanks to the flexibility thereof.

### Technical Solution

Therefore, the present invention provides a method of manufacturing a superabsorbent polymer fiber, comprising the steps of: (1) preparing a neutralization solution by dissolving a water-soluble ethylenic unsaturated monomer in a sodium hydroxide aqueous solution; (2) preparing a spinning solution by adding the neutralization solution with a crosslinking agent and performing stirring; and (3) producing a superabsorbent polymer fiber by subjecting the spinning solution to centrifugal spinning using a spinneret and then performing drying, wherein the neutralization solution has a neutralization degree of 40 to 90 mol %.

In addition, the present invention provides a superabsorbent polymer fiber, manufactured by the aforementioned method.

### Advantageous Effects

According to the present invention, a method of manufacturing a superabsorbent polymer fiber is advantageous in that a centrifugal spinning process is performed, and thus the device configuration is simple, energy consumption is low, fewer limitations are imposed on the spinning polymer, and the manufacturing process is simple due to the formation of a nonwoven fabric. Furthermore, unlike a superabsorbent polymer in powder form, the novel type of fiber having a superabsorbent polymer function can be provided in the form of a nonwoven fabric, thus causing no concern of scattering or leaking upon production thereof. Also, in the present invention, direct spinning on a substrate is possible during the production thereof, thus simplifying the manufacturing process, and the superabsorbent polymer fiber, which is flexible and has a variety of applications, can be obtained, thus enabling the expansion thereof to new application fields.

### BRIEF DESCRIPTION OF DRAWINGS

FIG. 1 shows a photograph of a superabsorbent polymer fiber (nonwoven fabric) according to an embodiment of the present invention; and

FIG. 2 shows a scanning electron microscope image of a superabsorbent polymer fiber (nonwoven fabric) according to an embodiment of the present invention.

### BEST MODE

Hereinafter, a detailed description will be given of the present invention.

The present invention addresses a method of manufacturing a superabsorbent polymer fiber, comprising the steps of: (1) preparing a neutralization solution by dissolving a water-soluble ethylenic unsaturated monomer in a sodium hydroxide aqueous solution; (2) preparing a spinning solution by adding the neutralization solution with a crosslinking agent and performing stirring; and (3) producing a superabsorbent polymer fiber by subjecting the spinning solution to centrifugal spinning using a spinneret and then performing drying, wherein the neutralization solution has a neutralization degree of 40 to 90 mol %.

Specifically, in step (1) of the method of manufacturing the superabsorbent polymer fiber according to the present invention, the neutralization solution is prepared by dissolving a water-soluble ethylenic unsaturated monomer in a sodium hydroxide aqueous solution.

In the method of manufacturing the superabsorbent polymer fiber according to the present invention, the water-soluble ethylenic unsaturated monomer is not particularly limited, so long as it is typically useful in the preparation of a superabsorbent polymer, and preferably includes any one or more selected from the group consisting of an anionic monomer and salts thereof, a nonionic hydrophilic monomer, and an amino group-containing unsaturated monomer and quaternary salts thereof. Specifically useful is at least one selected from the group consisting of anionic monomers and salts thereof, including isobutylene, acrylic acid, polyacrylic acid, methacrylic acid, maleic anhydride, fumaric acid, crotonic acid, itaconic acid, 2-acryloyl ethanesulfonic acid, 2-methacryloyl ethanesulfonic acid, 2-(meth)acryloyl propanesulfonic acid, and 2-(meth)acrylamide-2-methylpropanesulfonic acid; nonionic hydrophilic monomers, including (meth)acrylamide, N-substituted (meth)acrylate, 2-hydroxyethyl(meth)acrylate, 2-hydroxypropyl(meth)acrylate, methylacrylate, hydroxypropyl methacrylate, methoxypolyethyleneglycol (meth)acrylate, and polyethyleneglycol (meth)acrylate; and amino group-containing unsaturated monomers and quaternary salts thereof, including (N,N)-dimethylaminoethyl (meth)acrylate and (N,N)-dimethylaminopropyl (meth)acrylamide. More preferably useful is at least one selected from the group consisting of isobutylene, maleic anhydride, polyacrylic acid, acrylic acid, methyl acrylate, and hydroxypropyl methacrylate. Acrylic acid or a salt thereof is most preferable. When acrylic acid or a salt thereof is used as the monomer, a superabsorbent polymer fiber having improved absorption capability may be obtained. Meanwhile, in the method of manufacturing the superabsorbent polymer fiber according to the present invention, the concentration of the water-soluble ethylenic unsaturated monomer may be appropriately determined taking into consideration the reaction time and the reaction conditions, and the amount of the water-soluble ethylenic unsaturated monomer is preferably set to the range of 10 to 50 wt % based on the total weight of the sodium hydroxide aqueous solution. If the concentration of the water-soluble ethylenic unsaturated monomer is less than 10 wt %, economic benefits may be negated. On the other hand, if the concentration thereof exceeds 50 wt %, viscosity may increase and thus the spinning solution may not be spun via the spinneret, making it impossible to form a fiber phase.

The neutralization degree of the neutralization solution prepared in step (1) is preferably set within the range of 40 to 90 mol %, and more preferably 50 to 80 mol %. As used herein, the term “neutralization degree” is a value calculated using a predetermined equation upon the measurement of a water-soluble component. As the neutralization degree decreases, the absorption capability of the ultimately obtained superabsorbent polymer fiber may decrease.

In step (2) of the present invention, the spinning solution is prepared by adding the neutralization solution obtained in step (1) with the crosslinking agent and stirring it.

The crosslinking agent, which is added in the present invention, is not limited so long as it may react with the functional group of the polymer. In order to improve the properties of the resulting superabsorbent polymer fiber, the crosslinking agent preferably includes at least one selected from the group consisting of a polyhydric alcohol compound, an acrylate-based compound, an epoxy compound, a polyamine compound, a haloepoxy compound, a haloepoxy compound condensed product, an oxazoline compound, a mono-, di- or poly-oxazolidinone compound, a cyclic urea compound, a multivalent metal salt, and an alkylene carbonate compound. Particularly useful is an epoxy compound.

Specifically, the polyhydric alcohol compound may include at least one selected from the group consisting of mono-, di-, tri-, tetra- or poly-ethylene glycol, monopropylene glycol, 1,3-propanediol, dipropylene glycol, 2,3,4-trimethyl-1,3-pentanediol, polypropylene glycol, glycerol, polyglycerol, 2-butene-1,4-diol, 1,4-butanediol, 1,3-butanediol, 1,5-pentanediol, 1,6-hexanediol, and 1,2-cyclohexanedimethanol.

Also, the acrylate-based compound may be exemplified by poly(ethyleneglycol)diacrylate.

Also, examples of the epoxy compound may include ethylene glycol diglycidyl ether and glycidol, and the polyamine compound may include at least one selected from the group consisting of ethylene diamine, diethylene triamine, triethylene tetramine, tetraethylene pentamine, pentaethylene hexamine, polyethyleneimine, and polyamide polyamine

Examples of the haloepoxy compound may include epichlorohydrin, epibromohydrin, and α-methyl epichlorohydrin. The mono-, di- or poly-oxazolidinone compound may be exemplified by 2-oxazolidinone. An example of the alkylene carbonate compound may include ethylene carbonate. These compounds may be used alone or in combination. In order to increase the efficiency of the crosslinking process, the crosslinking agent preferably includes at least one polyhydric alcohol compound, and more preferably a polyhydric alcohol compound having 2 to 10 carbon atoms.

The amount of the crosslinking agent that is added to treat the surface of the polymer particles may be appropriately determined depending on the kind of crosslinking agent or the reaction conditions, and is generally set to the range of 0.001 to 5 wt %, preferably 0.01 to 3 wt %, and more preferably 0.05 to 2 wt %, based on the total weight of the water-soluble ethylenic unsaturated monomer. If the amount of the crosslinking agent is too small, the crosslinking reaction does not readily occur. On the other hand, if the amount thereof exceeds 5 wt % based on the total weight of the water-soluble ethylenic unsaturated monomer, the properties of the superabsorbent polymer may deteriorate somewhat due to the excessive crosslinking reaction.

In the following step (3), the spinning solution obtained in step (2) is placed in a spinneret so as to be centrifugally spun and is then dried, thereby producing a superabsorbent polymer fiber.

The centrifugal spinning is a process of producing a nonwoven fabric in a manner in which a polymer that is melted or dissolved is placed in a spinneret having multiple holes and rotated at high speed and the polymer that is not solidified is stretched using centrifugal force acting upon rotation, whereby refined and solidified fibers are stacked on a collector. Centrifugal spinning is advantageous in that the device configuration is simple, energy consumption is low, there are few limitations on the polymers that are usable, and the manufacturing process is simple due to the formation of a nonwoven fabric.

In an embodiment of the present invention, the rotation speed during the centrifugal spinning process is preferably set to, but is not limited to, the range of 3,000 rpm to 15,000 rpm. Upon centrifugal spinning at the above rotation speed, direct spinning on a substrate is possible, thus simplifying the manufacturing process.

In step (3), the drying may be performed at a drying temperature of 100 to 250° C. for 10 min to 120 min.

As used herein, the term “drying temperature” refers to the temperature of a heat medium supplied for the drying process or the temperature of a drying reactor containing a heat medium and a polymer in the drying process. If the drying temperature is lower than 100° C., the drying time may become excessively long, and the properties of the ultimately obtained superabsorbent polymer fiber may be deteriorated. On the other hand, if the drying temperature is higher than 250° C., only the surface of the fiber may be excessively dried, and thereby the properties of the ultimately obtained superabsorbent polymer fiber may be deteriorated. The drying is preferably carried out at a temperature of 100 to 250° C., and more preferably 160 to 200° C.

The drying time is not limited, but is preferably set to the range of 10 min to 120 min, and more preferably 20 min to 90 min, taking processing efficiency into account. Also, the drying process is not limited, so long as it is typically used in the art. Specifically, the drying process may be performed using hot air supply, IR irradiation, microwave irradiation, or UV irradiation.

In an embodiment of the present invention, the fiber is preferably a nonwoven fabric, but is not limited thereto.

According to the present invention, the superabsorbent polymer fiber is suitable for use in hygiene materials or resin-molded products. Here, the resin-molded products may include the polymer fiber of the aforementioned embodiment, or may be composed exclusively of such a polymer fiber.

The end use of such a disposable resin-molded product is not particularly limited, but may encompass molded products useful in various fields, such as medical, chemical, chemical engineering, food or cosmetic fields.

In addition, the present invention addresses a superabsorbent polymer fiber manufactured by the above method.

### MODE FOR INVENTION

A better understanding of the present invention may be obtained via the following examples, which are set forth to illustrate, but are not to be construed as limiting the scope of the present invention. The scope of the present invention is given by the claims, and also contains all modifications within the meaning and range equivalent to the claims. Unless otherwise mentioned, “%” and “part”, indicating amounts in the following examples and comparative examples, are given on a mass basis.

### EXAMPLES

### Example 1

### Production of Superabsorbent Polymer Fiber

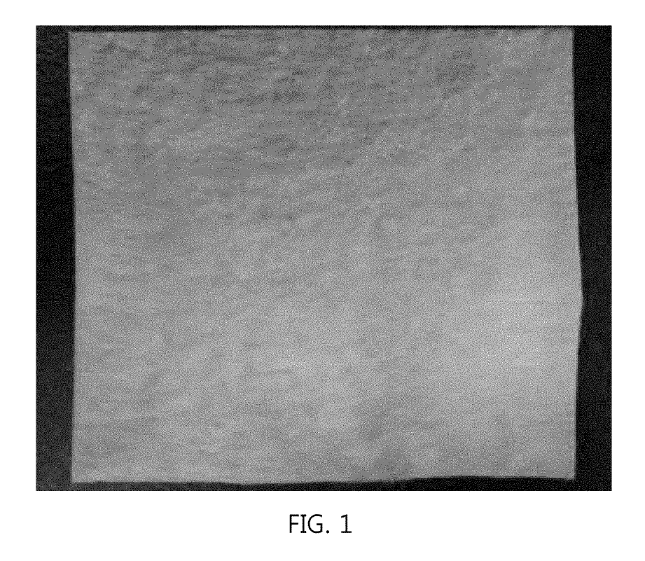

100 g of isobutylene/maleic anhydride and 41.5 g of caustic soda (sodium hydroxide) were dissolved in 330 g of water to give a solution having a solid content of 30 wt % and a neutralization degree of 80 mol %. This solution was then added with, as a crosslinking agent, epoxy (ethylene glycol diglycidyl ether, EX-810) in an amount of 0.3 wt %, based on the amount of isobutylene/maleic anhydride, and stirred so as to be completely mixed, thus preparing a spinning solution. 5 g of the spinning solution was placed in a spinneret having a hole size of 600 μm and spun at 10,000 rpm, whereby a sample was collected and then dried at 190° C. for 30 min, thereby manufacturing a superabsorbent polymer fiber nonwoven fabric. The nonwoven fabric thus obtained is shown in FIG. 1.

### Example 2

### Production of Superabsorbent Polymer Fiber

A superabsorbent polymer fiber nonwoven fabric was manufactured in the same manner as in Example 1, with the exception that the epoxy serving as the crosslinking agent was added in an amount of 1 wt % based on the amount of isobutylene/maleic anhydride.

### Example 3

### Production of Superabsorbent Polymer Fiber

100 g of polyacrylic acid and 27.8 g of caustic soda (sodium hydroxide) were dissolved in 734.7 g of water to give a solution having a solid content of 17.5 wt % and a neutralization degree of 50 mol %. This solution was then added with, as a crosslinking agent, epoxy (ethylene glycol diglycidyl ether, EX-810) in an amount of 0.3 wt % based on the amount of polyacrylic acid, and stirred so as to be completely mixed, thus preparing a spinning solution. 5 g of the spinning solution was placed in a spinneret having a hole size of 600 μm and spun at 5,000 rpm, whereby a sample was collected and then dried at 140° C. for 30 min, thereby manufacturing a superabsorbent polymer fiber nonwoven fabric.

### Example 4

### Production of Superabsorbent Polymer Fiber

100 g of a copolymer comprising acrylic acid, methyl acrylate, and hydroxypropyl methacrylate and 27.8 g of caustic soda were dissolved in 383.25 g of water to give a solution having a solid content of 25 wt % and a neutralization degree of 50 mol %. This solution was then added with, as a crosslinking agent, epoxy (ethylene glycol diglycidyl ether, EX-810) in an amount of 0.1 wt % based on the amount of the copolymer, and stirred so as to be completely mixed, thus preparing a spinning solution. 5 g of the spinning solution was placed in a spinneret having a hole size of 600 μm and spun at 7,000 rpm, whereby a sample was collected and then dried at 140° C. for 30 min, thereby manufacturing a superabsorbent polymer fiber nonwoven fabric.

### Comparative Example 1

### Production of Superabsorbent Polymer Fiber

A superabsorbent polymer fiber nonwoven fabric was manufactured in the same manner as in Example 2, with the exception that a solution having a neutralization degree of 35 mol % was spun.

### Comparative Example 2

### Production of Superabsorbent Polymer Fiber

A superabsorbent polymer fiber nonwoven fabric was manufactured in the same manner as in Example 2, with the exception that a solution having a neutralization degree of 95 mol % was spun.

The conditions of Examples 1 to 4 and Comparative Example 1 and 2 are shown in Table 1 below.

TABLE 1

| | A | B | Neutral- | | | |
|---|---|---|---|---|---|---|
| | concen- | concen- | ization | | Drying | Drying |
| | tration | tration | degree | | temperature | time |
| | (wt %) | (wt %) | (mol %) | Rpm | (° C.) | (min) |
| Ex. 1 | 30 | 0.3 | 80 | 10,000 | 190 | 30 |
| Ex. 2 | | 1 | | | | |
| Ex. 3 | 17.5 | 0.3 | 50 | 5,000 | 140 | |
| Ex. 4 | 25 | 0.1 | 50 | 7,000 | 140 | |
| C. Ex. 1 | 30 | 1 | 35 | 10,000 | 190 | |
| C. Ex. 2 | 30 | 1 | 95 | 10,000 | 190 | |

A: Water-soluble ethylenic unsaturated monomer
B: Crosslinking agent

### TEST EXAMPLES

### Test Example 1

### Evaluation of Properties of Superabsorbent Polymer Fiber Nonwoven Fabric—Centrifugal Retention Capacity (CRC)

The superabsorbent polymer fiber nonwoven fabrics of Examples 1 to 4 were measured for CRC. CRC was measured using the EDANA method WSP 241.3. Specifically, 0.2 g of the prepared superabsorbent nonwoven fabric was placed in a teabag and then immersed in a 0.9% saline solution for 30 min. Thereafter, dehydration was performed for 3 min at a centrifugal force of 250 G (gravity), and the amount of saline solution that was absorbed was measured.

### Test Example 2

### Evaluation of Properties of Superabsorbent Polymer Fiber Nonwoven Fabric—Absorption Under Load (AUL)

The superabsorbent nonwoven fabrics of Examples 1 to 4 were measured for AUL. AUL was measured using the EDANA method WSP 242.3. Specifically, 0.16 g of a sample of the prepared superabsorbent nonwoven fabric was placed in a cylinder according to EDANA, and a pressure of 0.3 psi was applied using a piston and a weight. Thereafter, the amount of 0.9% saline that was absorbed in 60 min was measured.

TABLE 2

| | CRC (g/g) | AUL (g/g) |
|---|---|---|
| Ex. 1 | 61.6 | 7.6 |
| Ex. 2 | 24.4 | 22.2 |
| Ex. 3 | 18.5 | 17.9 |
| Ex. 4 | 19.7 | 19.2 |
| C. Ex. 1 | 16.3 | 16.7 |
| C. Ex. 2 | 22.5 | 20.4 |

### Test Example 3

### Scanning Electron Microscope (SEM) Analysis

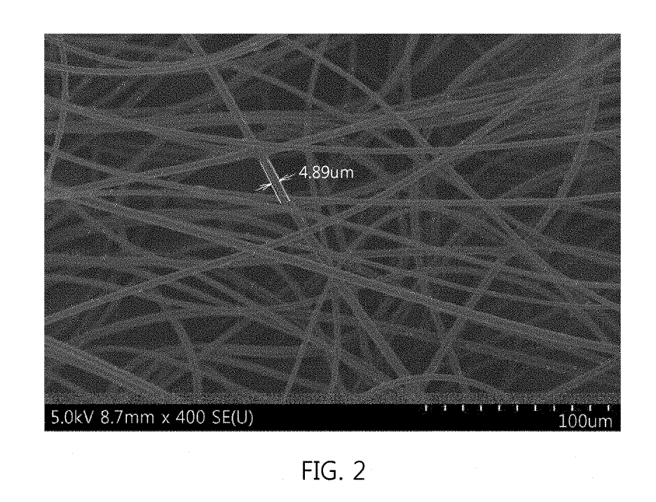

FIG. 2 shows the SEM image of the superabsorbent polymer fiber according to an embodiment of the present invention, as observed using a table SEM, for example, a Phenom Pro model available from PHENOM WORLD. Based on the results of magnified observation of the superabsorbent polymer fiber, a single strand of the fiber was measured to have a width of 4.89 μm.

As is apparent from the above results, the superabsorbent polymer fiber according to the present invention can be found to be a novel type of fiber having a superabsorbent polymer function in various CRC and AUL distribution ranges.

1. A method of manufacturing a superabsorbent polymer fiber, comprising steps of:
1) preparing a neutralization solution by dissolving a water-soluble ethylenic unsaturated monomer in a sodium hydroxide aqueous solution;
2) preparing a spinning solution by adding the neutralization solution with a crosslinking agent and then performing stirring; and
3) producing a superabsorbent polymer fiber by subjecting the spinning solution to centrifugal spinning using a spinneret and then performing drying,
wherein the neutralization solution has a neutralization degree of 40 to 90 mol %.

2. The method of claim 1, wherein the neutralization solution has a neutralization degree of 50 to 80 mol %.

3. The method of claim 1, wherein the water-soluble ethylenic unsaturated monomer is at least one selected from the group consisting of anionic monomers and salts thereof, including isobutylene, acrylic acid, polyacrylic acid, methacrylic acid, maleic anhydride, fumaric acid, crotonic acid, itaconic acid, 2-acryloyl ethanesulfonic acid, 2-methacryloyl ethanesulfonic acid, 2-(meth)acryloyl propanesulfonic acid, and 2-(meth)acrylamide-2-methylpropanesulfonic acid; nonionic hydrophilic monomers, including (meth)acrylamide, N-substituted (meth)acrylate, 2-hydroxyethyl(meth)acrylate, 2-hydroxypropyl(meth)acrylate, methylacrylate, hydroxypropyl methacrylate, methoxypolyethyleneglycol (meth)acrylate, and polyethyleneglycol (meth)acrylate; and amino group-containing unsaturated monomers and quaternary salts thereof, including (N,N)-dimethylaminoethyl (meth)acrylate and (N,N)-dimethylaminopropyl (meth)acrylamide.

4. The method of claim 1, wherein the water-soluble ethylenic unsaturated monomer is at least one selected from the group consisting of isobutylene, maleic anhydride, polyacrylic acid, acrylic acid, methylacrylate, hydroxypropyl methacrylate.

5. The method of claim 1, wherein the crosslinking agent is at least one selected from the group consisting of a polyhydric alcohol compound, an acrylate-based compound, an epoxy compound, a polyamine compound, a haloepoxy compound, a haloepoxy compound condensed product, an oxazoline compound, a mono-, di- or poly-oxazolidinone compound, a cyclic urea compound, a multivalent metal salt, and an alkylene carbonate compound.

6. The method of claim 1, wherein the crosslinking agent is an epoxy compound.

7. The method of claim 1, wherein the centrifugal spinning is performed at a rotation speed of 3,000 rpm to 15,000 rpm.

8. The method of claim 1, wherein in the preparing the neutralization solution of step 1), the water-soluble ethylenic unsaturated monomer is used in an amount of 10 to 50 wt % based on a total weight of the sodium hydroxide aqueous solution.

9. The method of claim 1, wherein in the preparing the spinning solution of step 2), the crosslinking agent is used in an amount of 0.001 to 5 wt % based on a total weight of the water-soluble ethylenic unsaturated monomer.

10. The method of claim 1, wherein in step 3), the drying is performed at a temperature of 100 to 250° C. for 10 min to 120 min.

11. The method of claim 1, wherein the fiber is a nonwoven fabric.

12. The method of claim 1, wherein the superabsorbent polymer fiber is used for manufacturing a hygiene material.
